(19) United States
(12) Patent Application Publication
(10) Pub. No.: US 2011/0035433 A1
(43) Pub. Date: Feb. 10, 2011

(54) WEBPAGE DISPLAY METHOD, COMPUTER SYSTEM, AND PROGRAM

(75) Inventors: Masaru Iwashita, Kawasaki (JP); Takeshi Anzai, Atlanta, GA (US); Masataka Kan, Yokohama (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/703,658

(22) Filed: Feb. 10, 2010

(30) Foreign Application Priority Data
Aug. 7, 2009 (JP) 2009-184676

(51) Int. Cl. G06F 17/00; G06F 15/16

(52) U.S. Cl. 709/203; 715/234

(57) ABSTRACT

In order to solve the problem that the building of a dynamic website requires large amounts of time and cost, this invention provides a method in which, by using a general-purpose script operating with a page transition type website so as to execute asynchronous communication instead of transition between pages through synchronous communication within a website, only a difference between a page acquired as a result of the asynchronous communication and a currently-displayed page is partially updated.

### CLAIM OF PRIORITY

The present application claims priority from Japanese patent application JP2009-184676 filed on Aug. 7, 2009, the content of which is hereby incorporated by reference into this application.

### BACKGROUND OF THE INVENTION

This invention relates to a method for improving operability of a website. More particularly, this invention relates to a method, a device, a system, and a program for improving operability of a webpage by executing asynchronous communication instead of executing transition between pages through synchronous communication within a website.

Conventionally, webpages have been developed based on a page described in the hypertext markup language (HTML). The reason for this is as follows. HTML enables pages having a hyperlink to be associated with each other, and accordingly, transition from one page to another is possible by using a link definition therebetween. As a result, content development on a page basis (referred to as page transition type website) is easy to understand, and has been widely accepted as an easy-to-use method.

In recent years, owing to development of the dynamic HTML (DHTML) technology using, for example, JavaScript, there has been an increasing use of such a website that enables of a content having high operability to be provided by performing asynchronous communication with a web server or dynamically updating a partial content (referred to as dynamic website). Unlike the conventional page transition type website, the dynamic website has a feature of displaying various contents within a single page without performing page transition.

A difference between the conventional page transition type website and the dynamic website is operational continuity for a user. The operational continuity for a user refers to whether or not the user can continue operation comfortably with the operation nondisruptive while the user is using a website. In the case of the page transition type website, in general, communication processing performed by a browser for acquiring a content from a server is executed synchronously with input operation of the user. For this reason, while the browser is executing the communication processing, the user cannot operate the browser, which results in generating an unnecessary waiting time. Moreover, in the case of the page transition type website, because a site is built on a page basis, information of the entire page needs to be acquired from the server and the entire screen needs to be rendered again even in a case where a small part of a content within a page is changed. As a result, costs of communication and rendering become high. To be kept waiting for a long time even in a case where only partial update is performed as described above does not fit the user's mental model, and hence the user feels that the waiting time is long. The above-mentioned factors cause the user's dissatisfaction with the websites.

On the other hand, in the case of the dynamic website, communication between the browser and the server is executed asynchronously from user operation, and hence the user can continue the operation while a content is being acquired from the server. Accordingly, with the enhanced operational continuity for the user, the dynamic website may resolve the user's dissatisfaction, and contributes to improving the level of the user's satisfaction with the website.

As the dynamic website having high operational continuity becomes widespread, there has been increasing dissatisfaction with the conventional page transition type website. Specifically, when a user who has become accustomed to the operational continuity of the dynamic website visits the page transition type website, the user feels that the operation of the site is slower than usual due to low operational continuity thereof. As described above, the operational continuity of the page transition type website relatively declines, and hence, compared to the past, there exist more cases where such a decline leads to damaging the reputation of a website or, eventually, a company providing the website.

In such a circumstance, in order to simplify the building of a dynamic website, various frameworks and libraries have been developed. Many of those frameworks and libraries are available for free and may be altered, and hence use of those frameworks and libraries is becoming widespread. However, those frameworks and libraries are intended for a case where a dynamic website is newly developed, and hence, when an existing page transition type website is modified into a dynamic website, the entire website needs to be rebuilt. For this reason, in a case where a large number of existing page transition type websites are to be modified into dynamic websites, it is actually difficult to rebuild all those websites, and hence the existing page transition type websites may not be modified into dynamic websites despite use of those frameworks and libraries. Further, even if those frameworks and libraries are used, in order to build a dynamic website, broad expertise and experience are required. Accordingly, even in a case where a website is newly created, it is not easy to build a website, and large amounts of cost and time are required for the building thereof.

As a method of easily building a webpage capable of displaying various contents within a single page and partially updating each of the contents, there is provided a method which utilizes an HTML frame. For example, in JP 10-105514 A, a page is divided using HTML frames, and the common gateway interface (CGI) is used to update the respective frames independently of one another, which enables keeping information to be displayed in the respective frames updated. However, in this method, each of the frames is associated with the existing page, and hence, even in a case where a part of the existing page is updated, all information pieces within a frame are rendered again. Therefore, the operational continuity thereof is as low as the operational continuity of the conventional page transition type website, and such a method may not be considered as a technology sufficient to resolve the user's dissatisfaction.

### SUMMARY OF THE INVENTION

In the conventional procedures for building a dynamic website, in a case where page transition type websites already exist, many of the page transition type websites need to be created again from the beginning. Thus, there has been a need of large amounts of cost and time in building the dynamic website. Because there are an enormous number of websites existing on the Internet, it is actually impossible to create all those websites again from the beginning. In addition, even in the case of newly building a website, due to high difficulty in building a dynamic website, the building of a dynamic website requires a long development period and a large amount of cost.

This invention solves the above-mentioned problem that the building of a dynamic website requires large amounts of time and cost.

In order to solve the above-mentioned problem, this invention provides a method in which, by using a general-purpose script operating with a page transition type website so as to execute asynchronous communication instead of transition between pages through synchronous communication within a website, only a difference between a page acquired as a result of the asynchronous communication and a currently-displayed page is partially updated.

According to this invention, by using the general-purpose script, it is possible to change an existing page transition type website into a dynamic website without making any modification, and hence enormous amounts of cost and development period required for building the dynamic website can be reduced. Further, in a case where a developer who is proficient in building the page transition type website attempts to newly build the dynamic website, owing to the use of the general-purpose script according to this invention, the developer only needs to build a conventional page transition type website to realize the dynamic website. Therefore, an effect of reducing load on the developer can also be obtained.

### BRIEF DESCRIPTION OF THE DRAWINGS

FIG. 1 is a block diagram illustrating an overview of a computer system and a use environment thereof according to the first embodiment of this invention.

FIG. 2 is a block diagram illustrating a detailed configuration of the client terminal according to the first embodiment.

FIG. 3 is a block diagram illustrating a detailed configuration of the browser 110 of the client terminal 100 according to the first embodiment.

FIG. 4 is a sequence diagram illustrating implementation procedures for processing performed between the browser 110 of the client terminal 100 and the web server 210 of the server 200 according to the first embodiment.

FIG. 5 is a flow chart of processing which is, among the above-mentioned procedures of FIG. 4, executed in the browser 110 of the client terminal according to the first embodiment.

FIG. 6 illustrates an example of the source code and screen of the document 1, which is an HTML document of the web server 210 according to the first embodiment.

FIG. 7 illustrates an example of the document 2, which is an HTML document of the web server 210 according to the first embodiment.

FIG. 8 is an example of an HTML document obtained as a result of analysis of the document 1 which is performed by the HTML analyzing module 310 according to the first embodiment

FIG. 9A is a flow chart of the processing of analyzing an HTML document which is executed by the HTML analyzing module 310 according to the first embodiment.

FIG. 9B is a flow chart of the recursive processing of analyzing an HTML document which is executed by the HTML analyzing module 310 according to the first embodiment.

FIG. 10 illustrates the structure of the event storage table 700 held by the browser 110 according to the first embodiment.

FIG. 11A is a flow chart illustrating an example of the processing of extracting a difference between HTML documents according to the first embodiment.

FIG. 11B is a flow chart illustrating an example of the recursive processing of reflecting the extracted difference according to the first embodiment.

FIG. 12 illustrates the second embodiment of this invention, and is a block diagram illustrating an overall configuration of a computer system.

FIG. 13 illustrates the third embodiment of this invention, and is a block diagram illustrating an overall configuration of a computer system.

### DETAILED DESCRIPTION OF THE PREFERRED EMBODIMENTS

### First Embodiment

Hereinbelow, with reference to the attached drawings, a first embodiment of this invention is described.

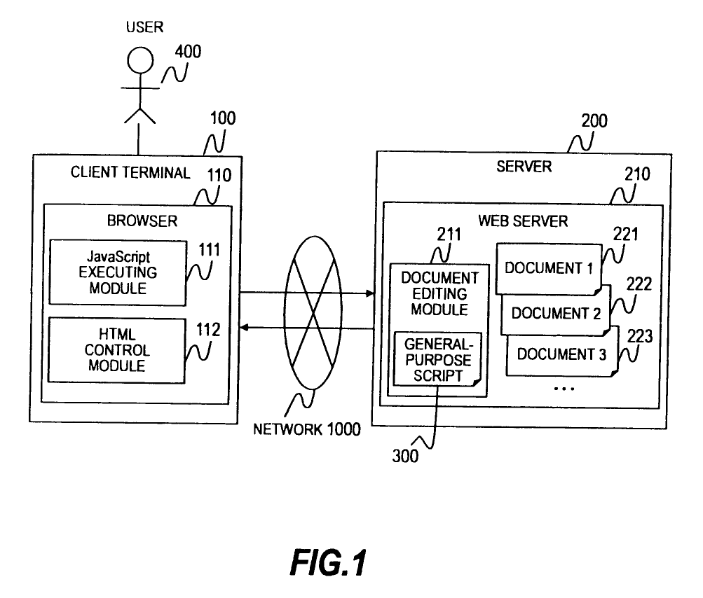

FIG. 1 is a block diagram illustrating an overview of a computer system and a use environment thereof according to the first embodiment of this invention.

A client terminal 100 is coupled to a server 200 via a network 1000. A browser 110 operating on the client terminal 100 sends, in response to a request from a user 400, a hypertext transfer protocol (HTTP) request to the server 200, and receives an HTTP response containing document data from the server 200. Thus, the browser 110 can acquire a document managed by the server 200 and display the document on the client terminal 100.

Here, the browser 110 is an application commonly used for displaying web contents on the Internet, and hence detailed description thereof is omitted. However, here, for the sake of description given below, an HTML control module 112 and a JavaScript executing module 111 are clearly described as an exception.

In the description given below, the HTML control module 112 has a function of analyzing HTML and a cascading style sheet (CSS) which are contained in the HTTP response received from the server 200, and displaying the HTML and the CSS on the client terminal 100. The JavaScript executing module 111 has a function of analyzing JavaScript contained in the HTTP response received from the server 200, and executing the JavaScript.

The server 200 includes a web server 210 which is always on standby for an HTTP request to be issued from the browser 110 or the like, and, upon reception of an HTTP request, sends document data specified by the HTTP request as the HTTP response. Further, in this embodiment, the web server 210 has a document editing function. The document editing function refers to a function of altering, prior to sending the HTTP response, document information to be contained in the HTTP response. This function is installed onto a commonly-used web server, and hence detailed description of an implementation method therefor is omitted. In this embodiment, by using the document editing function, the web server 210 performs processing of inserting a general-purpose script 300 into the document information to be sent by the web server 210. The structure of the general-purpose script 300 is described later.

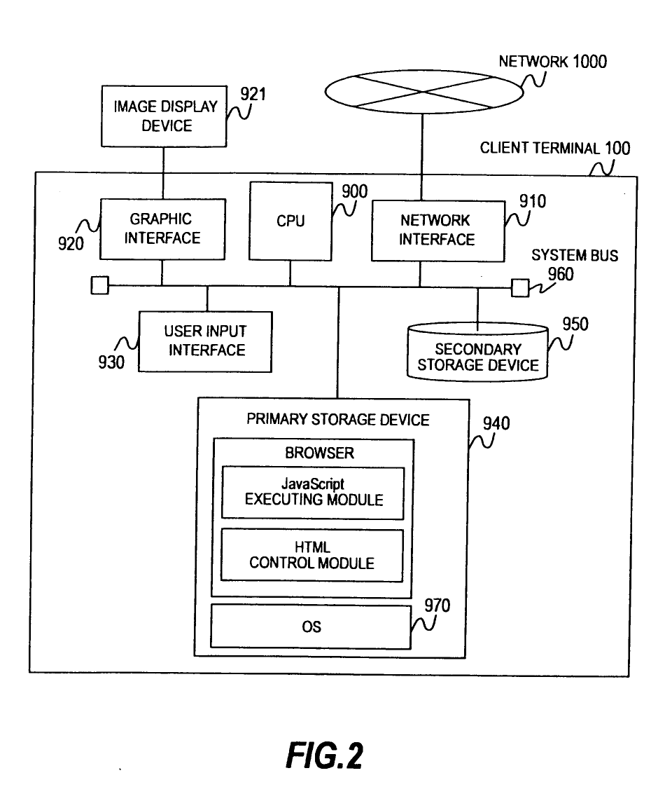

FIG. 2 is a block diagram illustrating a detailed configuration of the client terminal 100 used in this embodiment. The client terminal 100 includes a CPU 900, a network interface 910, a graphic interface 920, a user input interface 930, a primary storage device 940, a secondary storage device 950, and a system bus 960 for coupling those components.

The network interface 910 performs, according to an instruction from the CPU 900, communication with another computer or the like which is coupled thereto via the network 1000. The user input interface 930 has a function of receiving input of a user from an input device such as a mouse or a keyboard. The graphic interface 920 performs processing of displaying an image on an image display device 921 such as a display. The primary storage device 940 stores the browser 110 and an operating system (OS) 970, which are executed according to an instruction from the CPU 900. The secondary storage device 950 performs input/output of data according to an instruction from the CPU 900. The primary storage device 940 is a volatile storage device such as a memory, and the secondary storage device 950 is a nonvolatile storage device such as a magnetic storage device like a hard disk drive or an optical storage device like a CD drive or a DVD drive. However, the primary storage device 940 and the secondary storage device 950 are not limited thereto.

A hardware configuration of the server 200 is similar to the configuration illustrated in FIG. 2, but is different in that a program which is stored in the primary storage device and executed by the CPU 900 is a web server program (web server 210). Further, document data 221 to 223 managed by the web server 210 may be stored in the primary storage device 940, or alternatively, may be stored in the secondary storage device 950.

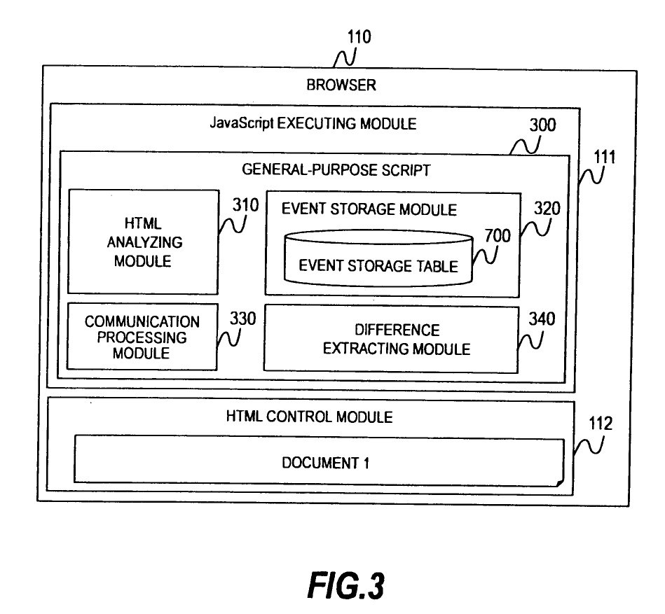

FIG. 3 is a block diagram illustrating a detailed configuration of the browser 110 of the client terminal 100.

When an HTML content added with the general-purpose script 300 is rendered, an HTML analyzing module 310 performs processing of analyzing the content of the HTML content, extracting link information which causes page transition, and changing a transition destination of the page to an event storage module 320. It should be noted that, as described in the section “BACKGROUND”, the page transition is established association between webpages using a hyperlink, and refers to transition from a current webpage to another webpage with the use of definition (link information) of the hyperlink.

The event storage module 320 stores, in an event storage table 700, a content of operation performed on the browser 110 by a user 400 and a result with respect to the content of the operation in association with each other. A detailed structure of the event storage table 700 is described later.

When the user 400 has clicked a link which causes the page transition, a communication processing module 330 acquires a content of the transition destination of the link. It should be noted that, as communication processing to be executed at the time of acquiring a content, asynchronous communication processing is used.

A difference extracting module 340 extracts a difference between the content acquired by the communication processing module 330 and a content which is currently displayed on a screen, and reflects, by handling the document object model (DOM), only a content corresponding to the difference thus extracted.

The above-mentioned processing modules 300, 310, 320, 330, and 340 are loaded into the primary storage device 940 as programs, and are executed by the CPU 900. Those processing modules 300, 310, 320, 330, and 340 are stored in the secondary storage device 950 serving as a storage medium.

The following description is given by assuming that the agent of processing is the above-mentioned programs to be executed according to instructions from the CPU 900.

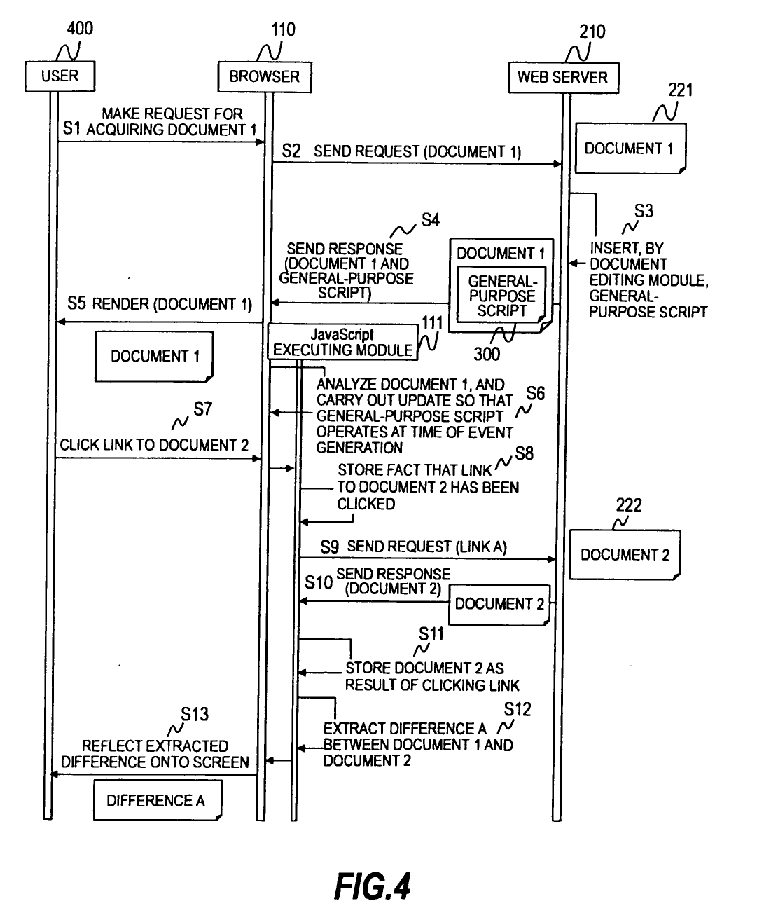

FIG. 4 is a sequence diagram illustrating implementation procedures for processing performed between the browser 110 of the client terminal 100 and the web server 210 of the server 200 according to this embodiment.

In this embodiment, first, the user 400 performs, with respect to the browser 110, operation of making a request for display of a given webpage (here, document 1 (221)). The browser 110 receives the operation via the user input interface 930 (S1).

The browser 110 which has received the request sends a request for acquiring the document 1 (221) to the web server 210 (S2).

The web server 210 which has received the request identifies the document 1. Next, the web server 210 executes processing of inserting the general-purpose script 300, which is described later, into the document 1 by using a document editing module 211 (S3). Lastly, the web server 210 generates a document 1 into which the general-purpose script 300 has been inserted, and then sends the document 1 to the browser 110 as response data (S4).

The browser 110 which has received a response (webpage) from the web server 210 analyzes the content of the document 1 and renders a result of the analysis on the graphic interface 920 of the client terminal 100 (S5), thereby responding to the request from the user 400. At the same time as the rendering of the response data described above (or after rendering processing), the browser 110 uses the JavaScript executing module 111 to start processing of the general-purpose script 300 embedded in the document 1.

The general-purpose script 300 is programmed so that, at the same time as document information is rendered on the graphic interface 920 of the client terminal 100, the JavaScript executing module 111 invokes the HTML analyzing module 310. The HTML analyzing module 310 operates (starts processing) when loaded into the browser 110, and performs processing of overwriting, with the event storage module 320, the link information contained in the document 1 (S6). The general-purpose script 300 is further programmed to stand by until the browser 110 issues some event based on operation of the user 400 after the processing of the HTML analyzing module 310 is finished. Specific details of the processing executed by the HTML analyzing module 310 are described later.

Next, it is assumed that, after the user 400 checks the content of the document 1, the user 400 clicks a link to a document 2 which is contained in the document 1 (S7). At this time, in the case of the prior art, the browser 110 directly makes a request for acquiring the document 2 to the web server 210. However, according to this invention, as described above, the transition destination is overwritten by the HTML analyzing module 310, and hence the browser 110 invokes the event storage module 320 stored in the JavaScript executing module 111.

The event storage module 320 stores, in the event storage table 700, a fact that the user 400 has clicked the link to the document 2 (S8), and invokes the communication processing module 330. A detailed structure of the event storage table 700 is described later.

In order to acquire the document 2 defined as the link, the communication processing module 330 makes a request for acquiring the document 2 to the web server 210 (S9). It should be noted that because the HTTP request issued by the communication processing module 330 uses the asynchronous communication, the user 400 does not need to wait while the communication processing module 330 is operating.

The web server 210 which has received the HTTP request from the communication processing module 330 sends the document 2 as an HTTP response (S10).

The communication processing module 330 which has received the response makes a notification to the event storage module 320 with the document 2 as a result of the reception. The event storage module 320 stores the document 2 in association with the event of clicking the link which is previously stored, and then invokes the difference extracting module 340 (S11).

The difference extracting module 340 extracts a difference between the HTML document (document 1) which is currently displayed for the user 400 and the document 2 (S12). Further, the difference extracting module 340 reflects only a partial content, which has been identified as a difference as a result of the difference extraction, to the display content by, for example, handling the DOM (document object model) managed by the HTML control module 112 (S13).

It should be noted that it is not essential for the event storage module 320 to carry out the step of storing the click event of the user in the event storage table 700 (S8) and the step of storing the reception result in association with the click event in the event storage table 700 (S11), and those steps may be omitted.

Difference extracting processing executed by the difference extracting module 340 is described later, and a feature of the difference extracting processing according to this invention is that, in a case where a difference extracted in the difference extracting processing is input information of an input element, the difference is not regarded as a difference. The reason for this is as follows. In the conventional page transition type website, the user operation and the communication processing are executed in a synchronous manner, whereas, in the method according to this invention, the user operation and the communication processing are executed in an asynchronous manner. Thus, when the user performs input operation during the communication processing, result information regarding this input operation is not contained in a content obtained as a result of the communication, and hence is extracted as a difference. If a result of simply performing the difference extraction is reflected, the result information regarding the input operation becomes lost, which may result in increasing dissatisfaction of the user. In order to prevent such a situation, it is desired that a difference corresponding to an input element be removed from a result of the difference extraction.

It should be noted that, as a method for preventing the loss of the user operation, instead of such a method of sorting out a particular result of the difference extraction, the user operation may be recovered based on the contents recorded in the event storage module 320, which is described later. Specifically, the event storage module 320 performs processing of recording operation history information of the user in chronological order. With this configuration, by referring to the event storage table 700 described later, it is possible to make a reference as to what operation the user has performed and what result the operation has generated since the start of communication. If this configuration is used, a result obtained from simple difference extraction is reflected onto the screen, and the user operation is allowed to become lost. Then, event data information recorded in the event storage module 320 is reflected onto the screen again, which enables reproducing the user operation. Therefore, such a method may also be used.

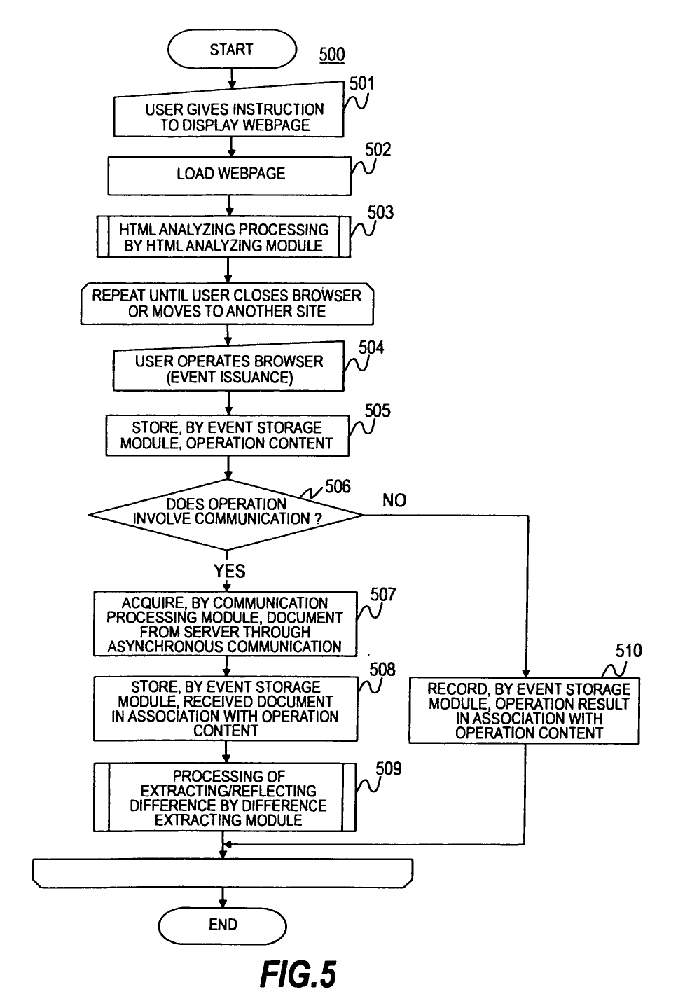

FIG. 5 is a flow chart of processing which is, among the above-mentioned procedures of FIG. 4, executed in the browser 110.

In this embodiment, first, the browser 110 executes Step 501 of receiving a request for display of a given webpage (here, document 1) from the user 400. The browser 110 which has received the request executes Step 502 of acquiring the document 1 from the web server 210.

The browser 110 which has received a response from the web server 210 uses the JavaScript executing module 111 to execute Step 503 of starting processing of the general-purpose script 300 embedded in the document 1 (HTML analyzing processing). Specific description of the HTML analyzing processing is given later.

Next, the browser 110 repeats the following processing until the user closes the browser 110 or moves to another website.

First, the browser 110 stands by until the user 400 performs such operation as a mouse click or keyboard input. When the user 400 has performed the operation, the browser 110 detects that event, and makes a notification to the event storage module 320 (Step 505).

The event storage module 320 executes Step 505 of storing a content of the operation performed by the user 400 in the event storage table 700. The structure of the event storage table 700 is described later.

Next, the event storage module 320 executes Step 506 of judging whether or not the operation performed by the user 400 is operation which involves communication. In the case of operation which involves communication, the processing proceeds to Step 507. It should be noted that whether or not the user operation is operation which involves communication may be determined based on the type of an event issued by the browser 110 in response to the operation of the user 400 and the type of an HTML element operated by the user 400.

In a case where the operation performed by the user 400 is operation which does not involve communication, the event storage module 320 executes Step 510 of recording the user operation in association with the event stored in Step 505 described above, and stands by until the next user operation is performed.

In the case where the operation performed by the user 400 is operation which involves communication, the communication processing module 330 executes Step 507 of acquiring document information from the server 200 through the asynchronous communication.

After the document information is received from the server 200, the communication processing module 330 notifies the event storage module 320 of the received information. Then, the event storage module 320 executes Step 508 of storing the information in association with the event stored in Step 505.

Lastly, the difference extracting module 340 executes Step 509 in which the processing of extracting a difference between the document information received by the communication processing module 330 and the document information which is currently displayed by the browser 110 and difference updating processing are executed, and stands by until the next user operation is performed. Detailed description of the processing executed by the difference extracting module 340 is given later.

It should be noted that, as described above, the steps (505, 508, and 510) executed by the event storage module 320 are not essential and may be omitted.

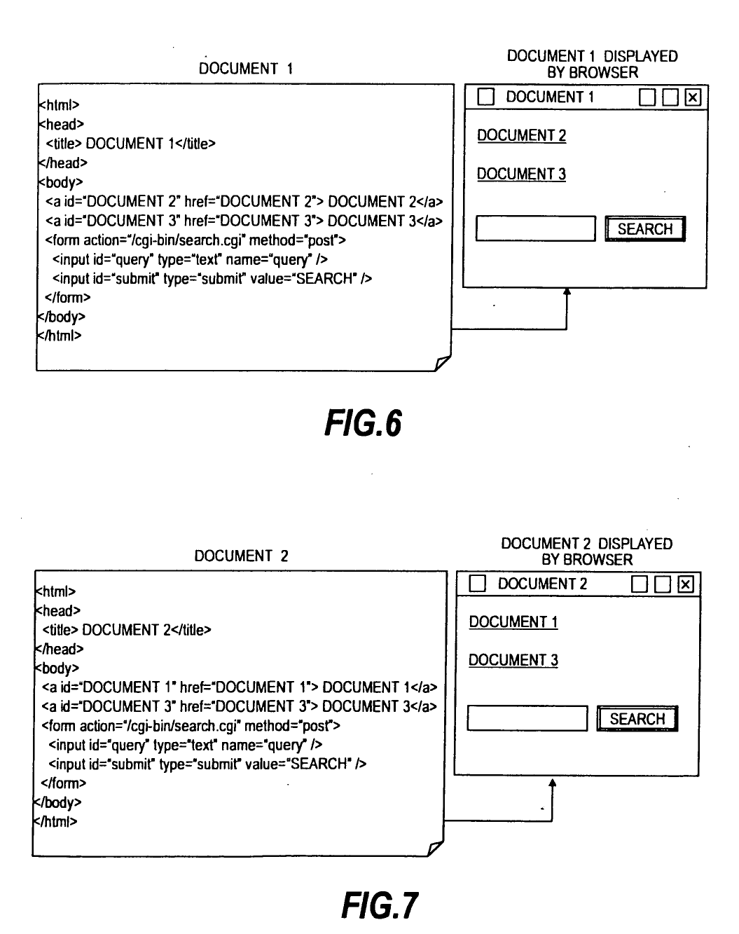

FIG. 6 illustrates an example of the source code and screen of the document 1, which is an HTML document of the web server 210.

The document 1 contains links (elements indicated by <a> tags of FIG. 6) to the document 2 and a document 3 and a form element. The form element includes a text field into which the browser 110 can perform input based on the operation performed by the user, and a button for issuing a request to the server 200.

FIG. 7 illustrates an example of the document 2, which is an HTML document of the web server 210. The structure of the document 2 is substantially the same as the structure of the document 1, but is different in that the link to the document 2 which is contained in the document 1 is replaced with a link to the document 1. Like this case, with regard to the conventional page transition type websites, there exist many cases in which a large number of contents having little difference from one another are stored.

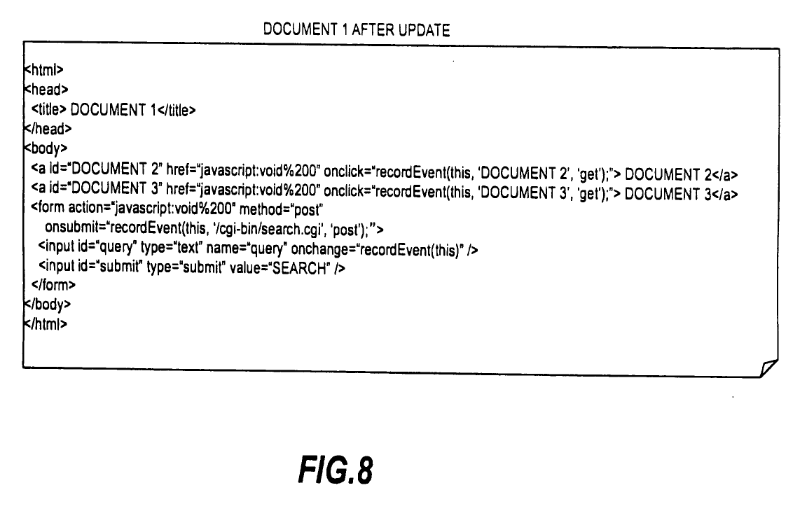

FIG. 8 is an example of an HTML document obtained as a result of analysis of the document 1 which is performed by the HTML analyzing module 310 contained in the general-purpose script 300. A difference from FIG. 6 is as follows. In FIG. 6, the value of an “href” attribute which defines the transition destination in the <a> tag indicating the link to the document 2 is a value “document 2” indicating the document 2 of the server 200, whereas, in FIG. 8, the value of the “href” attribute is changed to “javascript:void%200” and an “onclick” attribute is added. With this definition, in a case where the user 400 has clicked the link to the document 2, instead of directly acquiring the document 2, the browser 110 executes processing of “recordEvent” for invoking the event storage module 320 contained in the general-purpose script 300.

Similarly, in order to notify the event storage module 320 of a corresponding event in a case where the user 400 has sent a form or has updated the content of the text field, an “onsubmit” attribute and an “onchange” attribute are added to the form element and the text field, respectively.

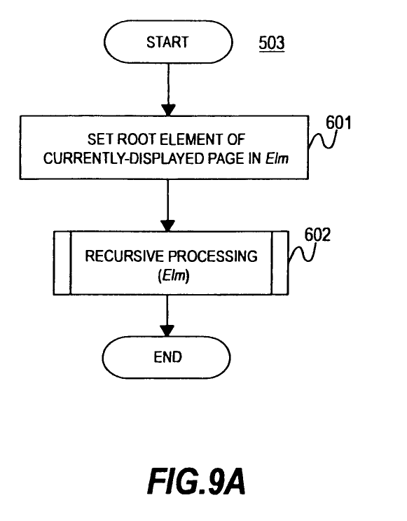

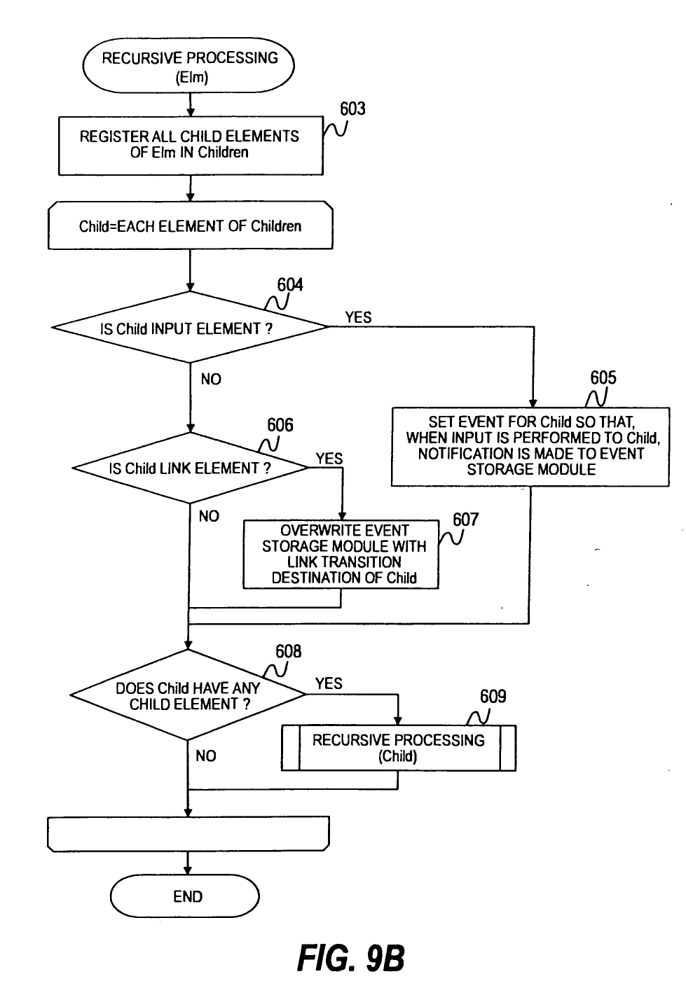

FIG. 9A and FIG. 9B are flow charts of the processing of analyzing an HTML document which is executed by the HTML analyzing module 310. Hereinbelow, taking FIGS. 6 and 8 as an example, details of the HTML analyzing processing are described.

Referring to FIG. 9A, the HTML analyzing module 310 first executes Step 601 of acquiring a root element of the currently-displayed HTML content. Here, the root element means a tag positioned at the top level among the tags constituting the HTML content. For example, in FIG. 6, an <html> tag corresponds to the root element.

Next, the HTML analyzing module 310 executes Step 602 of applying recursive processing with the root element as an argument, and then finishes the processing.

With reference to FIG. 9B, description is given of the recursive processing of Step 602 which is executed by the HTML analyzing module 310.

First, the HTML analyzing module 310 executes Step 603 of enumerating all child elements of a provided element. Here, the all child elements of the provided element are a set of all elements existing immediately below the provided element. For example, as the child elements corresponding to the <html> tag of FIG. 6, a <head> tag and a <body> tag are enumerated.

The HTML analyzing module 310 applies the following processing to each (Child) of the elements (Children) enumerated in Step 603.

The HTML analyzing module 310 first executes Step 604 of examining whether or not Child is an input element. In a case where Child is not an input element, the processing proceeds to Step 606.

In a case where Child is an input element, the HTML analyzing module 310 executes Step 605 of setting an event for the Child element so that, when the user has performed input operation with respect to Child, the event storage module 320 can detect that input operation.

Here, the input element is an element operable by the user, such as a text input field, a radio button, or a check box. In the case where the Child element is an input element, for an event which is issued by the browser based on the user's operation, such as an “onclick” event or an “onchange” event, processing to be executed when the event is issued is set. As a result, the event storage module 320 is invoked as the processing executed at the time of generation of the event. Specifically, as can be seen in an element having “query” set as an “id” attribute thereof in FIG. 8, “recordEvent(this)” is set as the value of the “onchange” attribute. After the event is set, the processing proceeds to Step 608.

In the case where Child is not an input element, the HTML analyzing module 310 executes Step 606 of judging whether or not Child is a link element. In a case where Child is not a link element, the processing proceeds to Step 608.

In a case where Child is a link element, the HTML analyzing module 310 executes Step 607 of overwriting a link destination of Child with the event storage module 320. Here, the link element is an element indicating a link for transition to another document, such as the <a> tag or a <form> tag of FIGS. 6 and 8. To give a specific processing example, as illustrated in FIG. 8, the “href” attribute of the <a> tag is changed to “javascript:void%200”, and further, the onclick attribute is added and the value thereof is set to “recordEvent(this, link destination document, HTTP method name)”, as a result, setting is made so that the event storage module 320 is invoked when the link is clicked. Similarly, in the case of the “form” element, by overwriting an “action” attribute and a “submit” attribute, setting is made so that the event storage module 320 is invoked at the time of sending a form.

Next, the HTML analyzing module 310 executes Step 608 of examining whether or not Child has a child element. In a case where Child has a child element, the HTML analyzing module 310 executes Step 609 of executing the recursive processing with respect to Child. In a case where Child does not have a child element, the HTML analyzing module 310 repeats the same processing with respect to a next element included in Children. Further, in a case where Child is the last child element included in Children, the recursive processing is finished.

Through the above-mentioned processing, all input elements and link elements which are contained in the HTML received from the server 200 can be extracted, and processing to be executed when an event is issued can be overwritten for the extracted elements. Accordingly, every time the user 400 performs any operation, the content of the operation is notified to the event storage module 320.

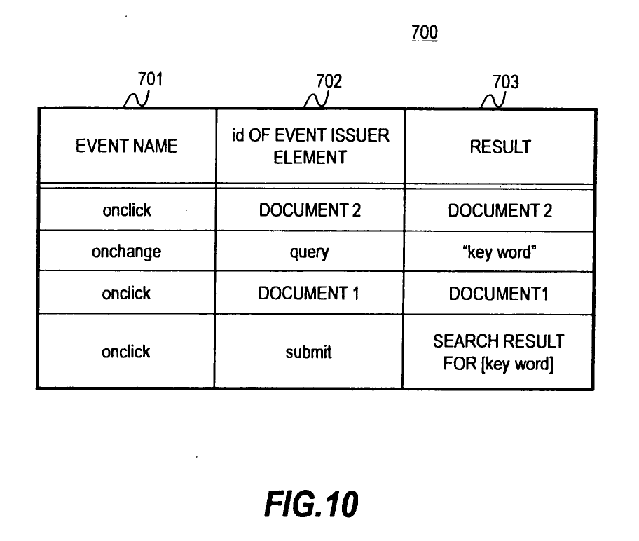

FIG. 10 illustrates the structure of the event storage table 700 held by the browser 110. The event storage table 700 is a table for storing data to be stored by the event storage module 320 contained in the general-purpose script 300. It should be noted that, in FIG. 10, a table format is used, but the structure is not limited to a database, the data may be recorded in areas such as JavaScript variables, or Cookie, and there is no particular limitation imposed thereon.

The event storage table 700 includes a column 701 for recording the name of an event issued by the browser 110 based on the user's operation, a column 702 for indicating the “id” attribute of an event issuer element, and a column 703 for storing a result of issuing an event. It should be noted that information to be stored in the column 702 may be any information as long as HTML elements can be identified, and therefore is not limited to the “id” attribute.

When the user 400 has performed operation with respect to an input element or a link element, the event storage module 320 is executed with the operation as a trigger. The event storage module 320 records an event name, an HTML element of an event issuance source, and a result obtained through execution of the corresponding event.

Specifically, in a case where the user 400 has clicked a link element, an HTML document which is the destination of the clicked link is recorded. Apart from that, in a case where a user input element (for example, text field) has been changed, a value obtained as a result of the change is recorded. In FIG. 10, the following are recorded. First, the user 400 clicks an element having the “id” attribute set as “document 2”, and, as a result of the click, the document 2 is acquired. Subsequently, the user 400 inputs “key word” into an element having the “id” attribute set as “query”. Then, the user 400 clicks an element having the “id” attribute set as “document 1”, and, as a result, the document 1 is acquired. Further, the user 400 clicks an element having the “id” attribute set as “submit”, and, as a result, a search result for pages related to the “key word” is acquired.

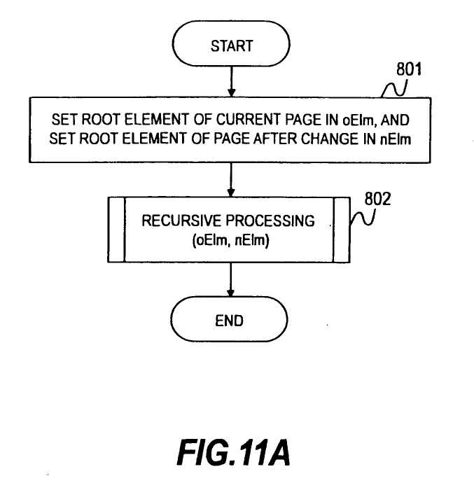

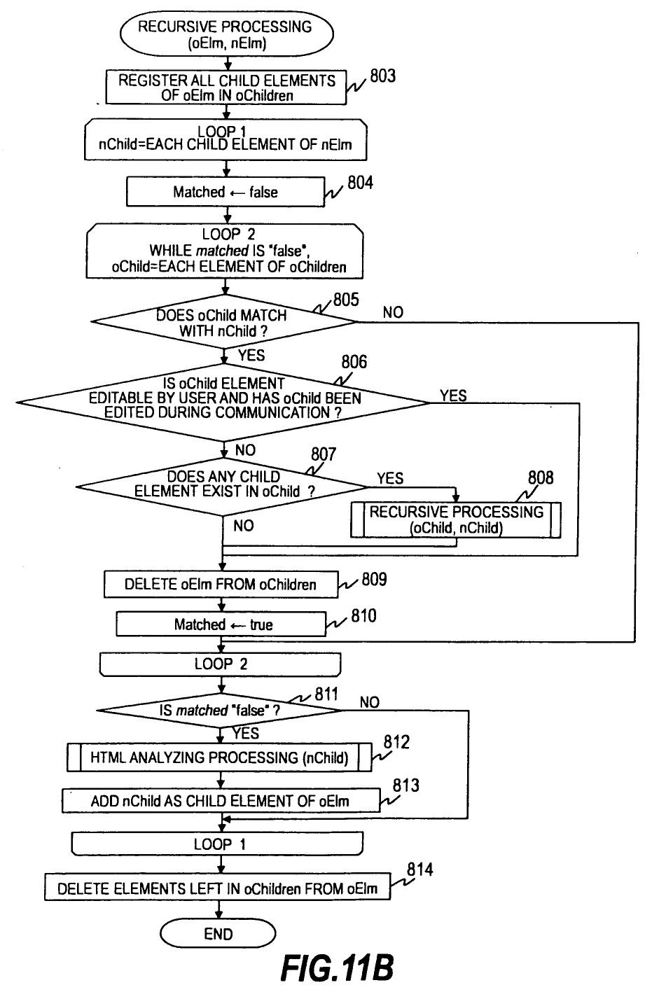

FIG. 11A and FIG. 11B are flow charts illustrating an example of the processing of extracting a difference between HTML documents and processing of reflecting the extracted difference, which are executed by the difference extracting module 340 included in the general-purpose script 300.

Referring to FIG. 11A, first, the difference extracting module 340 executes Step 801 of setting, as a variable oElm, the root element of a currently-displayed document, and setting, as a variable nElm, the root element of a document which is received by the communication processing module 330 and is to be displayed after the change. For example, in a case where transition is made from the document 1 illustrated in FIG. 6 to the document 2 illustrated in FIG. 7, the <html> tag of the document 1 and the <html> tag of the document 2 are set in the variable oElm and the variable nElm, respectively.

The difference extracting module 340 executes Step 802 of applying recursive processing with the variables oElm and nElm set in the above as arguments, and then finishes the processing. As illustrated in FIG. 11B, the recursive processing is processing for performing a search for elements constituting the variable nElm, extracting a difference from the variable oElm, and reflecting the detected difference onto the screen of the image display device 921.

Hereinbelow, with reference to FIG. 11B, description is given of the recursive processing executed by the difference extracting module 340.

First, the difference extracting module 340 executes Step 803 of registering all child elements of the variable oElm in oChildren. For example, in a case where the variable oElm is the <html> tag of the document 1, the <head> tag and the <body> tag of the document 1 are registered in oChildren.

The difference extracting module 340 applies the following processing to each (nChild) of all the child elements of the variable nElm. This means that in a case where the variable nElm is the <html> tag of the document 2, the <head> tag and the <body> tag of the document 2 are each set as nChild and subjected to the following processing.

First, the difference extracting module 340 executes Step 804 of setting “false” in a variable matched.

Next, while the variable matched is set to “false”, the difference extracting module 340 repeats the following processing with respect to the elements (referred to as oChild) included in oChildren.

The difference extracting module 340 executes Step 805 of judging whether or not nChild matches with oChild. In a case where nChild does not match with oChild, the difference extracting module 340 selects a next oChild, and repeats this step. In a case where nChild matches with oChild, the processing proceeds to Step 806, which is the next step. Here, whether or not nChild matches with oChild may be determined based on, for example, whether or not the values of the “id” attributes of the HTML match with each other. Apart from that, whether or not the elements of the HTML match with each other may be determined based on the attribute values of the elements, the structures of the child elements of the HTML, or the like. With further refinement thereof, it is possible to realize difference extraction of higher accuracy. However, such refinement is not relevant to the essence of this invention, and also, a conventional difference extraction technology may be utilized. Hence, description thereof is omitted herein.

Next, the difference extracting module 340 executes Step 806 of judging whether or not oChild is an element editable by the user and whether or not oChild has been changed during the communication. In a case where oChild has been changed, the processing proceeds to Step 809, and the variable oChild is removed from oChildren. After that, in Step 811, the variable matched is set to “true”, and a loop 2 is finished.

In a case where oChild is not an element editable by the user, the difference extracting module 340 executes Step 807 of judging whether or not any child element exists in oChild.

In a case where a child element exists in oChild, the difference extracting module 340 invokes the recursive processing with oChild and nChild set as the arguments (Step 808).

In a case where no child element exists in oChild, the difference extracting module 340 executes Step 809 of deleting the variable oChild from oChildren, and, in Step 810, sets the variable matched to “true” to finish the loop 2.

After the loop 2 is finished, the difference extracting module 340 executes Step 811 of checking whether or not the variable matched is “false”. In a case where the variable matched is “false”, it is possible to determine that nChild is a new element which is not contained in the currently-displayed screen. In this case, first, the difference extracting module 340 executes Step 812 of executing, with nChild set as the argument, the recursive processing of the HTML analyzing processing (Step 503) illustrated in FIG. 9A. With this configuration, even in a case where the user 400 has issued an event with respect to an element extracted as a difference, a notification is made to the event storage module 320. Subsequently, the difference extracting module 340 executes Step 813 of adding nChild as a child element of the variable oElm. In a case where the variable matched is “true”, the processing proceeds to Step 814.

Lastly, the difference extracting module 340 executes Step 814 of deleting elements which are left in oChildren from the variable oElm. This is because the elements which are left in oChildren are such elements that are contained in the currently-displayed document but are not contained in the document after the change. Thus, such elements need to be deleted from the variable oElm.

With the above-mentioned procedures, according to this invention, the link element contained in the existing page is overwritten, and only difference information between the link destination content acquired by using the asynchronous communication and the currently-displayed content is reflected on the screen. As a result, while utilizing the existing page transition type websites, a website comparable to dynamic websites in operational continuity can be built. Therefore, it is possible to reduce cost or time spent in building a dynamic website.

Further, with the application of this invention, a page transition type website is changed to a dynamic website. As a result, for a user of the website, because the operational continuity is improved, such as reduction in unnecessary waiting time at the time of viewing the website, there is obtained an effect of improving the comfort at the time of viewing the website.

### Second Embodiment

Next, with reference to the drawing, a second embodiment is described.

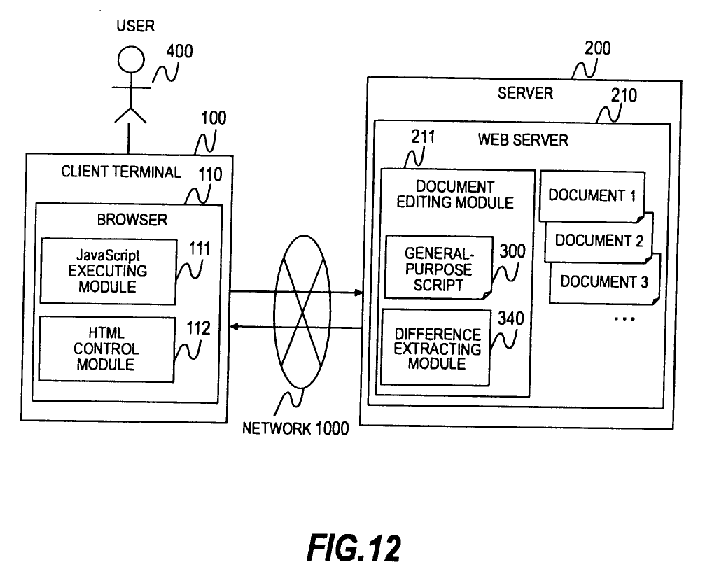

FIG. 12 illustrates the second embodiment of this invention, and is a block diagram illustrating an overall configuration of a computer system.

In this embodiment, the difference extracting module 340 included in the general-purpose script 300 according to the first embodiment is provided to the web server 210.

With the application of this embodiment, before the web server 210 sends a content to the browser 110, the web server 210 extracts a difference between a document sent the last time and a document to be sent this time, which therefore enables reduction in communication amount. The details of processing performed by a difference extracting module 340 according to the second embodiment are similar to the details of the processing performed by the difference extracting module 340 according to the first embodiment.

Upon reception of a request for acquiring a document from the browser 110, the web server 210 performs processing of inserting the general-purpose script 300 into the corresponding document, and extracts a difference (partial content) between document information sent as a response to the browser 110 the last time and document information requested from the browser 110 this time to thereby send only difference information to the browser 110. In the browser 110 which has received the difference information, the JavaScript executing module 111 executes the general-purpose script 300, and only the difference information is reflected on displaying of the browser 110.

### Third Embodiment

Next, with reference to the drawing, a third embodiment is described.

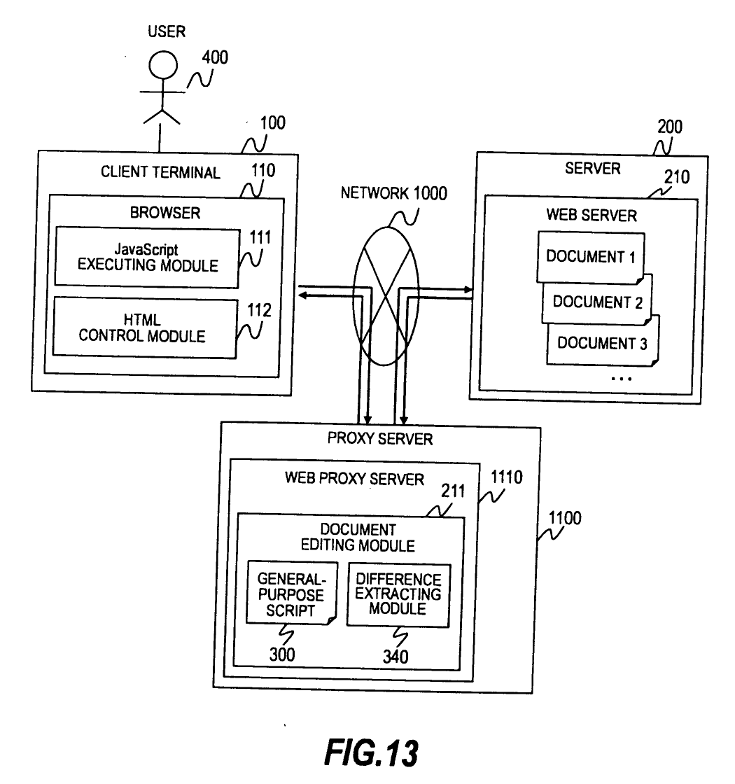

FIG. 13 illustrates the third embodiment of this invention, and is a block diagram illustrating an overall configuration of a computer system. In this embodiment, the document editing module 211 and the difference extracting module 340 provided to the web server 210 according to the second embodiment are provided to a web proxy server 1110 operating on a proxy server 1100 which serves as an intermediary between the browser 110 and the web server 210.

The proxy server 1100 is a general-purpose computer having the same configuration as the client terminal 100. Further, the web proxy server 1110 can be implemented with a general-purpose web proxy program. Therefore, detailed description is omitted herein.

Upon reception of a request for acquiring a document from the browser 110, the web proxy server 1110 transfers, without any modification, the received request to the web server 210. The web server 210 which has received the request sends the corresponding document information to the web proxy server 1110 as a response. The web proxy server 1110 which has acquired the document information performs processing of inserting the general-purpose script 300 into the document, and extracts a difference between document information sent as the response to the browser 110 the last time and the document information received from the web server 210 this time to thereby send only difference information to the browser 110. In the browser 110 which has received the difference information, the JavaScript executing module 111 executes the general-purpose script 300, and only the difference information is reflected on displaying of the browser 110. This processing is the same as the difference reflection processing according to the second embodiment.

As described above, this invention is applicable to a computer system including a web server and a client terminal for executing a browser, and a program for a browser, a web server, or a proxy server.

While the present invention has been described in detail and pictorially in the accompanying drawings, the present invention is not limited to such detail but covers various obvious modifications and equivalent arrangements, which fall within the purview of the appended claims.

What is claimed is:

1. A webpage display method used for a computer comprising:
a processor for performing arithmetic processing;
a storage unit coupled to the processor;
a display device coupled to the processor;
an input unit for receiving operation from a user; and
a communication processing unit for exchanging a webpage with a server,
the computer being configured to:
make a request for the webpage to the server;
analyze the webpage received from the server; and
output the webpage to the display device,
the webpage display method comprising:
analyzing information contained in the webpage received by the communication processing unit, and extracting event information for generating page transition;
overwriting the event information so that, when an event corresponding to the extracted event information is issued, the communication processing unit performs processing of the event information;
issuing the event corresponding to the operation received by the input unit;
performing, by the communication processing unit, when the event is issued, communication with the server asynchronously from processing of another processing unit, and receiving a webpage of a transition destination from the server;
extracting a difference between the webpage displayed on the display device when the event is issued and the webpage of the transition destination which is received from the server by the communication processing unit; and
outputting only the extracted difference to the display device.

2. The webpage display method according to claim 1, wherein the extracting a difference between the webpage displayed on the display device when the event is issued and the webpage of the transition destination which is received from the server by the communication processing unit comprises discriminating, from the extracted difference, difference information of an element capable of receiving the operation from the user, and reflecting, onto the display device, only difference information excluding the difference information of the received operation from the user.

3. The webpage display method according to claim 1, further comprising:
storing the issued event in an event storage unit set in the storage unit;
changing the transition destination of the webpage which is indicated by the extracted event information to the event storage unit;
storing the event issued in response to the operation received by the input unit in the event storage unit; and
storing, in the event storage unit, information on the webpage of the transition destination which is received by the communication processing unit from the server in association with the stored event issued based on the operation from the user.

4. The webpage display method according to claim 3, wherein the outputting only the extracted difference to the display device comprises reproducing, after only the extracted difference is output to the display device, by using the event stored in the event storage unit, an event issued in a time period spanning from generation of the event of the page transition until the communication processing unit receives the webpage of the transition destination from the server.

5. The webpage display method according to claim 1, wherein:
the performing, by the communication processing unit, when the event is issued, communication with the server asynchronously from processing of another processing unit, and receiving a webpage of a transition destination from the server comprises:
extracting, by the server, a difference between the webpage sent as a response last time and the webpage for which the request is currently made, and sending the extracted difference to the computer; and
receiving, by the communication processing unit, the difference as the webpage of the transition destination; and
the extracting a difference between the webpage displayed on the display device when the event is issued and the webpage of the transition destination which is received from the server by the communication processing unit comprises setting the difference received from the server as the difference between the webpage displayed on the display device and the webpage of the transition destination.

6. The webpage display method according to claim 1, wherein:
the computer and the server comprise a proxy server for relaying the communication therebetween; and
the performing, by the communication processing unit, when the event is issued, communication with the server asynchronously from processing of another processing unit, and receiving a webpage of a transition destination from the server comprises:
extracting, by the proxy server, a difference between the webpage sent as a response last time and the webpage for which the request is currently made, and sending the extracted difference to the computer; and
receiving, by the communication processing unit, the difference as the webpage of the transition destination; and
the extracting a difference between the webpage displayed on the display device when the event is issued and the webpage of the transition destination which is received from the server by the communication processing unit comprises setting the difference received from the proxy server as the difference between the webpage displayed on the display device and the webpage of the transition destination.

7. A computer system, comprising a computer, wherein:
the computer comprises:
a processor for performing arithmetic processing;
a storage unit coupled to the processor;
a display device coupled to the processor;
an input unit for receiving operation from a user; and
a communication processing unit for receiving a webpage from a server;
the computer is configured to:
make a request for the webpage to the server;
analyze the webpage received from the server; and
output the webpage to the display device;
the computer further comprises:
an HTML analyzing unit for analyzing information contained in the webpage, and changing the information; and
a difference extracting unit for extracting a difference of the webpage;
the HTML analyzing unit is configured to:
extract, upon reception of the webpage from the server, event information for generating page transition and a webpage of a transition destination;
overwrite the event information so that the communication processing unit performs processing which is to be performed when an event corresponding to the extracted event information occurs; and
issue the event corresponding to the operation received by the input unit;
the communication processing unit performs, when the event is issued, communication with the server asynchronously from processing of another processing unit, and receives the webpage of the transition destination from the server; and
the difference extracting unit is configured to:
extract a difference between the webpage displayed on the display device when the event is issued and the webpage of the transition destination which is received from the server by the communication processing unit; and
output the difference to the display device.

8. The computer system according to claim 7, wherein the difference extracting unit discriminates, from the extracted difference, difference information of an element capable of receiving the operation from the user, and reflects, onto the display device, only difference information excluding the difference information of the received operation from the user.

9. The computer system according to claim 7, wherein:
the computer further comprises an event storage unit for storing the issued event; and
the computer is further configured to:
change the transition destination of the webpage which is indicated by the extracted event information to the event storage unit;
store the event issued in response to the operation received by the input unit in the event storage unit; and
store, in the event storage unit, information on the webpage of the transition destination which is received by the communication processing unit from the server in association with the stored event issued based on the operation from the user.

10. The computer system according to claim 9, wherein the difference extracting unit reproduces, after only the difference is output to the display device, by using the event stored in the event storage unit, an event issued in a time period spanning from generation of the event of the page transition until the communication processing unit receives the webpage of the transition destination from the server.

11. The computer system according to claim 7, wherein:
the server extracts a difference between the webpage sent as a response last time and the webpage for which the request is currently made, and sends the extracted difference to the computer;
the communication processing unit receives the difference as the webpage of the transition destination; and
the difference extracting unit sets the difference received from the server as the difference between the webpage displayed on the display device and the webpage of the transition destination.

12. The computer system according to claim 7, further comprising a proxy server for relaying communication between the computer and the server, wherein:
the proxy server extracts a difference between the webpage sent as a response last time and the webpage for which the request is currently made, and sends the extracted difference to the computer;
the communication processing unit receives the difference as the webpage of the transition destination; and
the difference extracting unit sets the difference received from the proxy server as the difference between the webpage displayed on the display device and the webpage of the transition destination.

13. A machine-readable medium storing a program to be executed by a computer stored thereon,
the computer comprising:
a processor for performing arithmetic processing;
a storage unit coupled to the processor;
a display device coupled to the processor;
an input unit for receiving operation from a user; and
a communication processing unit for exchanging a webpage with a server,
the program controlling the computer to:
make a request for the webpage to the server;
analyze the webpage received from the server; and
output the webpage to the display device,
the program further controlling the computer to execute the procedures of:
analyzing information contained in the webpage received by the communication processing unit, and extracting event information for generating page transition;
overwriting the event information so that, when an event corresponding to the extracted event information is issued, the communication processing unit performs processing of the event information;
issuing the event corresponding to the operation received by the input unit;
performing, by the communication processing unit, when the event is issued, communication with the server asynchronously from processing of another processing unit, and receiving a webpage of a transition destination from the server;
extracting a difference between the webpage displayed on the display device when the event is issued and the webpage of the transition destination which is received from the server by the communication processing unit; and
outputting only the extracted difference to the display device.

14. The machine-readable medium storing the program stored thereon according to claim 13, wherein the procedure of extracting a difference between the webpage displayed on the display device when the event is issued and the webpage of the transition destination which is received from the server by the communication processing unit comprises the procedure of discriminating, from the extracted difference, difference information of an element capable of receiving the operation from the user, and reflecting, onto the display device, only difference information excluding the difference information of the received operation from the user.

15. The machine-readable medium storing the program stored thereon according to claim 13, wherein the program further controls the computer to execute the procedures of:
storing the issued event in an event storage unit set in the storage unit;
changing the transition destination of the webpage which is indicated by the extracted event information to the event storage unit;
storing the event issued in response to the operation received by the input unit in the event storage unit; and
storing, in the event storage unit, information on the webpage of the transition destination which is received by the communication processing unit from the server in association with the stored event issued based on the operation from the user.

16. The machine-readable medium storing the program stored thereon according to claim 15, wherein the procedure of outputting only the extracted difference to the display device comprises reproducing, after only the extracted difference is output to the display device, by using the event stored in the event storage unit, an event issued in a time period spanning from generation of the event of the page transition until the communication processing unit receives the webpage of the transition destination from the server.

17. The machine-readable medium storing stored therein the program according to claim 13, wherein:
the procedure of performing, by the communication processing unit, when the event is issued, communication with the server asynchronously from processing of another processing unit, and receiving a webpage of a transition destination from the server comprises receiving, by the communication processing unit, from the server, a difference between the webpage sent as a response last time and the webpage for which the request is currently made, and receiving the difference as the webpage of the transition destination; and
the procedure of extracting a difference between the webpage displayed on the display device when the event is issued and the webpage of the transition destination which is received from the server by the communication processing unit comprises setting the difference received from the server as the difference between the webpage displayed on the display device and the webpage of the transition destination.

18. The machine-readable medium storing stored therein the program according to claim 13, wherein:
the procedure of performing, by the communication processing unit, when the event is issued, communication with the server asynchronously from processing of another processing unit, and receiving a webpage of a transition destination from the server comprises extracting, by a proxy server disposed between the server and the computer, a difference between the webpage sent as a response last time and the webpage for which the request is currently made, and receiving the difference as the webpage of the transition destination; and
the procedure of extracting a difference between the webpage displayed on the display device when the event is issued and the webpage of the transition destination which is received from the server by the communication processing unit comprises setting the difference received from the proxy server as the difference between the webpage displayed on the display device and the webpage of the transition destination.
